(19) United States
(12) Patent Application Publication
(10) Pub. No.: US 2008/0252674 A1
(43) Pub. Date: Oct. 16, 2008

(54) Liquid ejecting apparatus and method of controlling same

(75) Inventor: Iwao Ushinohama, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION

(21) Appl. No.: 12/075,407

(22) Filed: Mar. 11, 2008

(30) Foreign Application Priority Data
Apr. 10, 2007 (JP) P2007-102304

(51) Int. Cl. B41J 29/38

(52) U.S. Cl. 347/14

(57) ABSTRACT

A liquid ejecting apparatus for ejecting droplets by driving heat generating elements includes an electrical current source configured to output temperature measurement current; a plurality of head chips, each having a heat generating element, a temperature sensor whose resistance value changes with temperature, a switch circuit that connects the temperature sensor to the electrical current source, and a switch-circuit control circuit configured to control the switch circuit; and a heat-generating-element control circuit configured to measure temperatures of the plurality of head chips and controlling the driving of the heat generating elements via an end of the electrical current source on the temperature sensor side. The temperature sensors of the plurality of head chips are sequentially and selectively connected to the electrical current source by the switch circuits of the plurality of head chips, and the temperatures of the plurality of head chips are measured by the heat-generating-element control circuit.

### CROSS REFERENCES TO RELATED APPLICATIONS

The present invention contains subject matter related to Japanese Patent Application JP 2007-102304 filed in the Japanese Patent Office on Apr. 10, 2007, the entire contents of which are incorporated herein by reference.

### BACKGROUND OF THE INVENTION

1. Field of the Invention

The present invention relates to a liquid ejecting apparatus and a method of controlling the liquid ejecting apparatus, and can be applied to, for example, a thermal line printer. In the present invention, an electrical current source for measuring temperature is shared among a plurality of head chips, temperature sensors of each of the head chips are sequentially and selectively connected to the electrical current source, and the temperature of each head chip is measured at the end of the electrical current source side, thereby miniaturizing the configuration for temperature measurement in comparison with the related art.

2. Description of the Related Art

In the related art, in a thermal printer, which is a liquid ejecting apparatus, heat generating elements provided in head chips of the thermal printer are driven to eject ink droplets. Here, the head chip is a semiconductor substrate on which a plurality of heat generating elements, a driving circuit for driving a plurality of heat generating elements, and the like are formed, and is fabricated by a semiconductor manufacturing process. In a thermal printer, the printer head is constituted by the head chip.

Regarding this type of printer, in a line printer disclosed in, for example, Japanese Unexamined Patent Application Publication No. 2005-131845, a printer head is formed by arraying a plurality of head chips, thereby the print width of the printer head is increased.

Here, in the thermal printer, the temperature of the head chip is increased as a result of the driving of the heat generating elements. As a result, in the thermal printer, when there is a difference in the number of times heat generating elements are driven among head chips, a difference in temperature occurs among the head chips. The temperature difference causes the amount of ink droplets ejected to vary among the head chips, and print mottling occurs.

For this reason, in this type of thermal printer, for example, the temperature of each head chip is periodically measured by using the configuration shown in FIG. 7, and the driving of the heat generating element in each head chip is controlled on the basis of the temperature measurement result.

That is, a printer 1 shown in FIG. 7 is, for example, a line printer, and head chip groups 3A to 3D constituted by a plurality of head chips 2A, 2B, . . . , 2N are provided for each color of ink to be used for printing. Here, each of the head chips 2A, 2B, . . . , 2N inputs image print data supplied from a central processing unit (CPU) 4 to a data decoder 5, and causes heat generating elements 6 to generate heat in accordance with the image print data under the control of a driving circuit 6 by the data decoder 5. As a result, in the printer 1, ink droplets are adhered to paper in accordance with the image print data, and a desired image is printed.

Each of the head chips 2A, 2B, . . . , 2N is provided with a temperature sensor 8 whose resistance value changes with, for example, temperature, and a fixed current for measuring temperature is supplied from constant current sources 9AA to 9DN to temperature sensors 8 of the head chips 2A, 2B, . . . , 2N, respectively. As a result, in each of the head chips 2A, 2B, . . . , 2N, the terminal voltage of the temperature sensor 8 changes with temperature. Selection circuits 10A to 10D receive the terminal voltage of the temperature sensor 8 for each of the head chip groups 3A to 3D, sequentially switch contact points, and output the terminal voltage of each temperature sensor 8 to an analog-to-digital conversion circuit (A/D) 11. The analog-to-digital conversion circuit 11 performs an analog-to-digital conversion process on the terminal voltage input from the selection circuits 10A to 10D. The central processing unit 4 sequentially obtains the output value of the analog-to-digital conversion circuit 11 in synchronization with the switching of the selection circuits 10A to 10D and, in response, measures the temperature of each of the head chips 2A, 2B, . . . , 2N on a time-division basis. When the temperature of the head chip increases, on the basis of the measurement result, the central processing unit 4 decreases the driving energy of the corresponding heat generating element by an amount corresponding to the increase in temperature, thereby preventing print mottling due to temperature differences among the head chips.

In the printer 1 having the configuration shown in FIG. 7, wiring patterns that connect the output ends of the temperature sensor 8 to the selection circuits 10A to 10D are necessary, the number of wiring patterns corresponding to the number of head chips. Therefore, problems arise in that the area of a motherboard on which the central processing unit 4 and the like are arranged becomes enlarged and the area of the configuration that connects the motherboard to the printer becomes enlarged. In particular, in the line printer, the number of head chips is also increased. As a result, as printing paper becomes larger, the area of the configuration of the motherboard and the wiring that connects the motherboard and the printer head becomes markedly enlarged.

### SUMMARY OF THE INVENTION

The present invention has been made in view of the above points. It is desirable to provide a liquid ejecting apparatus in which the configuration for temperature measurement can be miniaturized, and a method of controlling the liquid ejecting apparatus.

According to an embodiment of the present invention, there is provided a liquid ejecting apparatus for ejecting droplets by driving heat generating elements, the liquid ejecting apparatus including: an electrical current source configured to output temperature measurement current; a plurality of head chips, each having a heat generating element, a temperature sensor whose resistance value changes with temperature, a switch circuit that connects the temperature sensor to the electrical current source, and a switch-circuit control circuit configured to control the switch circuit; and a heat-generating-element control circuit configured to measure temperatures of the plurality of head chips and controlling the driving of the heat generating elements via an end of the electrical current source on the temperature sensor side, wherein the temperature sensors of the plurality of head chips are sequentially and selectively connected to the electrical current source by the switch circuits of the plurality of head chips, and the temperatures of the plurality of head chips are measured by the heat-generating-element control circuit.

According to another embodiment of the present invention, there is provided a method for controlling a liquid ejecting apparatus for ejecting droplets by driving heat generating elements, the liquid ejecting apparatus including an electrical current source configured to output temperature measurement current, and a plurality of head chips, each having a heat generating element, a temperature sensor whose resistance value changes with temperature, and a switch circuit that connects the temperature sensor to the electrical current source, the control method including the steps of: sequentially and selectively connecting the temperature sensors of the plurality of head chips by using the switch circuits of the plurality of head chips, and sequentially measuring temperatures of the plurality of head chips via an end of the electrical current source on the temperature sensor side; and controlling the driving of the heat generating elements on the basis of the measurement result in the temperature measurement.

According to the embodiments of the present invention, the temperature sensors of a plurality of head chips can be sequentially and selectively connected to the electrical current source, and the temperatures of the plurality of head chips can be measured. Therefore, it is possible to reduce the number of wirings of the head chips used to measure temperature. As a result, it is possible to miniaturize the configuration for temperature measurement in comparison with the related art.

### BRIEF DESCRIPTION OF THE DRAWINGS

FIG. 1 is a block diagram showing a configuration for temperature measurement in a printer according to a first embodiment of the present invention;

FIG. 2 is a perspective view showing the printer according to the first embodiment of the present invention;

FIG. 3 is an exploded perspective view illustrating a printer head in the printer of FIG. 2;

FIG. 4 is an exploded perspective view illustrating a head chip in the printer of FIG. 2;

FIG. 5 is a block diagram showing a detailed configuration of a head chip for temperature measurement in FIG. 1;

FIG. 6 is a time chart illustrating temperature measurement in FIG. 1; and

FIG. 7 is a block diagram illustrating temperature measurement of the related art.

### DESCRIPTION OF THE PREFERRED EMBODIMENTS

Embodiments of the present invention will now be described below in detail as appropriate with reference to the drawings.

### First Embodiment

### (1) Configuration of the Embodiment

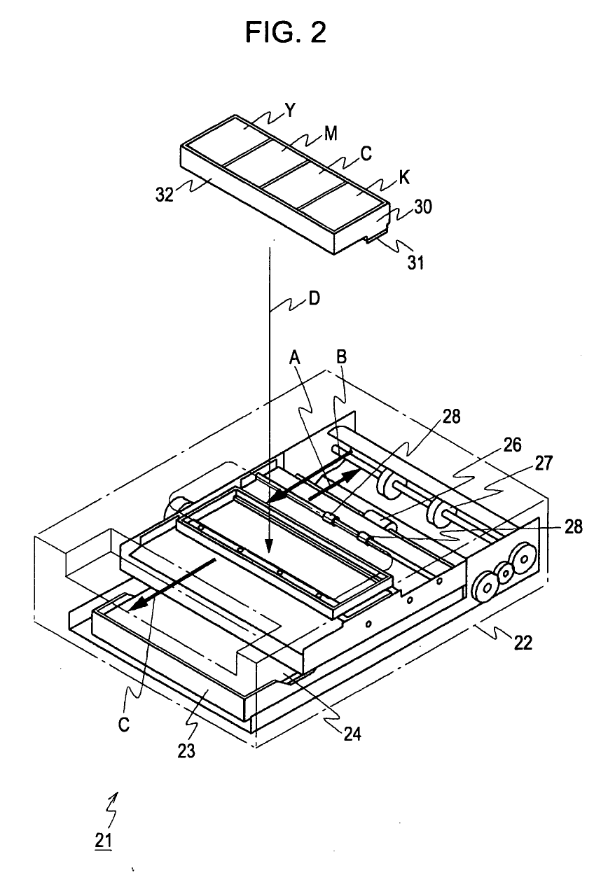

FIG. 2 is a perspective view showing a printer 21 according to a first embodiment of the present invention. The printer 21 is a line printer. The entirety thereof is formed in such a manner as to be housed in a rectangular housing 22, and a paper tray 23 in which printing paper 24 is housed is installed from the tray entry formed in the front side of the housing 22.

Here, when the paper tray 23 is installed in the printer 21, a predetermined mechanism causes the printing paper 24 to be pressed against a paper feed roller 26, and as a result of the paper feed roller 26 being rotated, the printing paper 24 is transported toward the side opposite the paper tray 23, as indicated by an arrow mark A. In the printer 21, an inversion roller 27 is disposed on the side at which the paper is fed, and as a result of the inversion roller 27 being rotated, the transport direction of the printing paper 24 is switched toward the front direction, as indicated by an arrow mark B.

In the printer 21, the printing paper 24, in the case that the paper feeding direction has been switched, is transported by a spur roller 28 or the like in such a manner as to traverse the paper tray 23, and is ejected from an ejection port disposed on the front side, as indicated by an arrow mark C. In the printer 21, from the spur roller 28 to the ejection port, a head cartridge 30 is exchangeably disposed, as indicated by an arrow mark D.

Here, in the head cartridge 30, a printer head 31 for a line printer is disposed on the bottom side of a holder 32 having a predetermined shape, and ink cartridges Y, M, C, and K of yellow, magenta, cyan, and black, respectively, are disposed in sequence in the holder 32. In the head cartridge 30, inks held in the ink cartridges Y, M, C, and K are supplied to the printer head 31, and the printer head 31 causes these inks in the form of ink droplets to be adhered to the printing paper 24, thereby printing a desired color image.

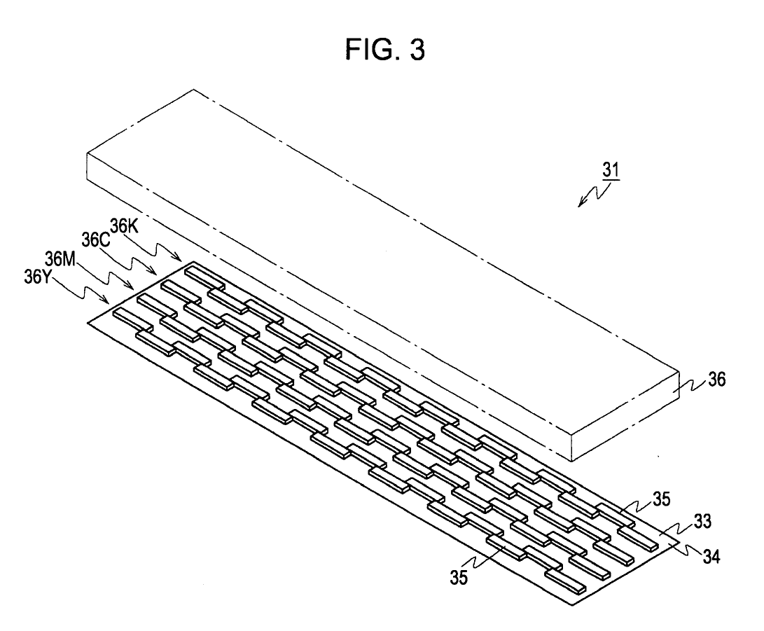

As shown in an exploded perspective view of FIG. 3 viewed from the same direction as in FIG. 2, in the printer head 31, a nozzle plate 33 is produced by producing a nozzle or the like in a sheet member formed of, for example, a carbon-type resin, and the nozzle plate 33 is held in a frame (not shown). In the printer head 31, a dry film 34 formed of a carbon-type resin having a predetermined shape is disposed on the nozzle plate 33, and then, head chips 35 are sequentially arranged.

In the printer head 31, the head chips 35 are formed in such a manner as to be arranged in four lines in a direction traversing the printing paper 24 so as to correspond to printing of yellow, magenta, cyan, and black. In the printer head 31, thereafter, projecting and recessed portions are formed on the surface on the head chip 35 side, and a metal plate member 36 in which an ink flow path is formed with the ink cartridge is disposed, and thereafter each head chip 35 is connected. As a result, the printer head 31 is provided with head chip groups 36Y, 36M, 36C, and 36K constituted by head chips 35 in charge of printing of yellow, magenta, cyan, and black, respectively.

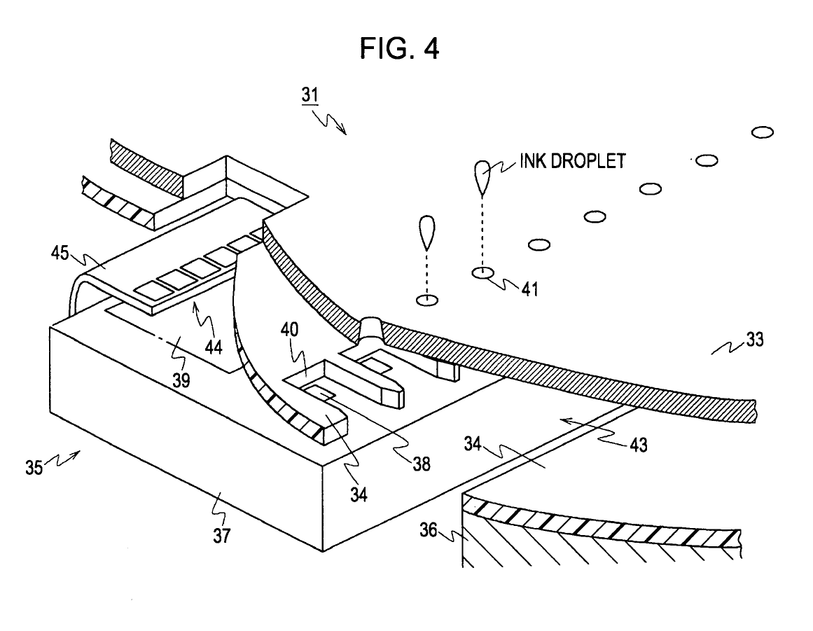

FIG. 4 is a sectional view showing one of the head chips 35 together with the peripheral configuration. The head chip 35 is formed by processing a silicon substrate 37 by using an integrated circuit technology, and heat generating elements 38 for heating ink are arranged in a line. Also, a driving circuit 39 for driving the heat generating elements 38 is formed. In the printer head 31, the nozzle plate 33 is processed so that a circular-shaped opening is disposed in each heat generating element 38, and a partition wall of each heat generating element 38 is formed using a dry film 34. As a result, an ink liquid chamber 40 is produced in each heat generating element 38, and a nozzle 41 for ejecting ink droplets is produced using the nozzle plate 33.

In the head chip 35, the heat generating element 38 is disposed in the vicinity of the side surface thereof. In the dry film 34, on the side on which the heat generating element 38 is disposed, a partition wall is produced so as to have a comb shape so that the ink liquid chamber 40 is exposed. In the printer head 31, the ink flow path 43 is formed by the metal plate member 36 and the dry film 34 so that inks of the ink cartridges Y, M, C, and K are guided from the exposed side. As a result, in the printer head 31, ink is guided from the edge side in the longitudinal direction of the head chip 35 to the ink liquid chamber 40 of each heat generating element 38.

In the head chip 35, a pad 44 is formed on the side opposite the side where the heat generating element 38 is disposed, a flexible wiring substrate 45 is connected to the pad 44, and image print data, power, and the like are input via the flexible wiring substrate 45. In this embodiment, 320 heat generating elements 38 are provided in one head chip 35, 16 head chips 35 are allocated for each color of ink, and 64 head chips 35 are allocated in total.

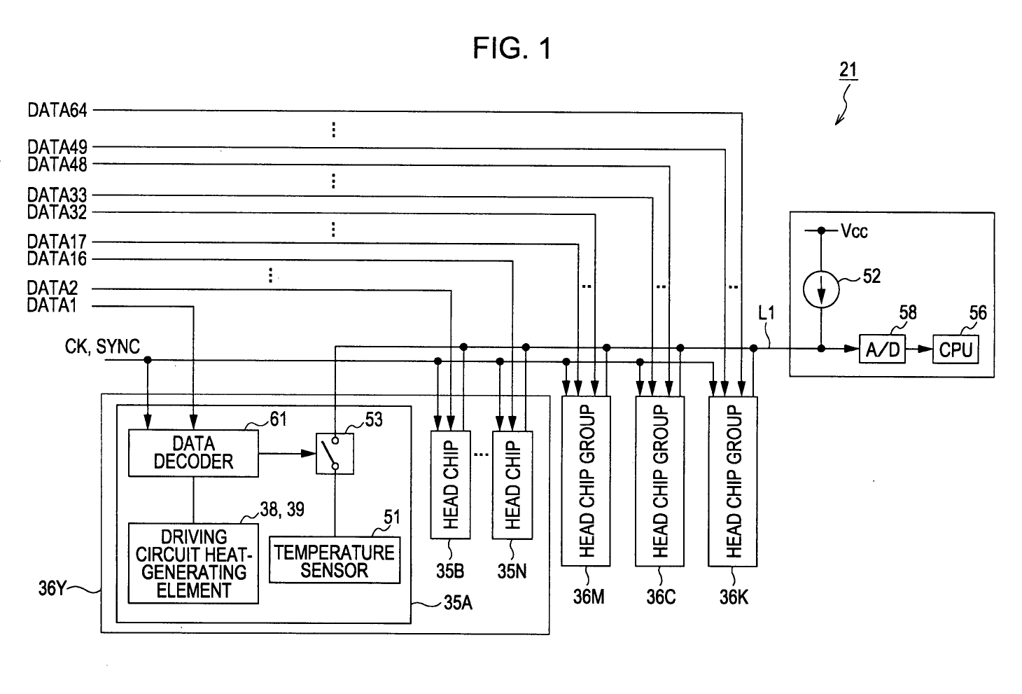

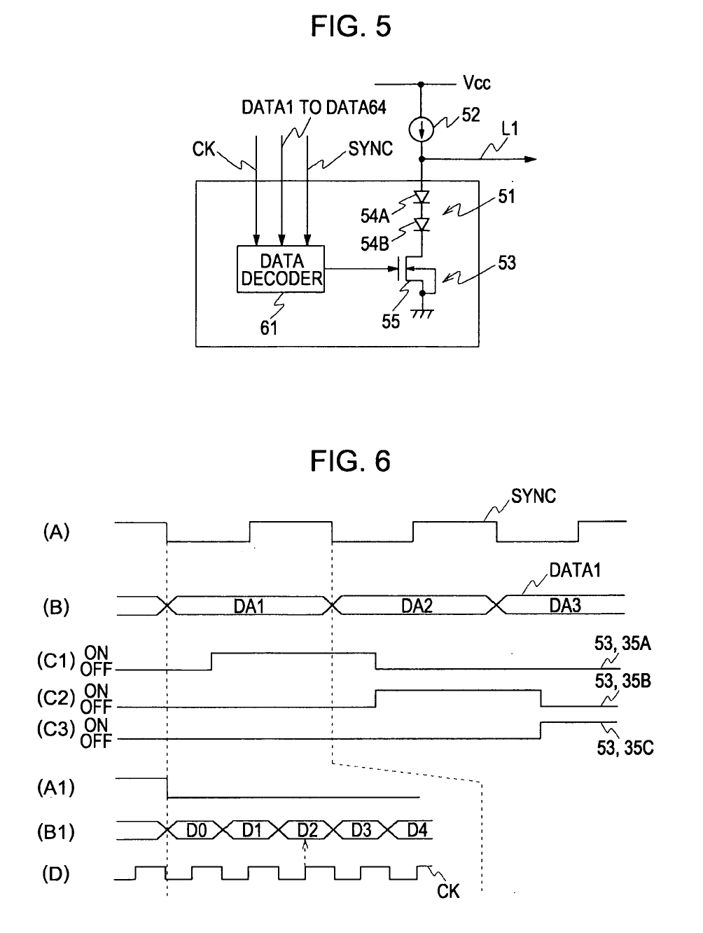

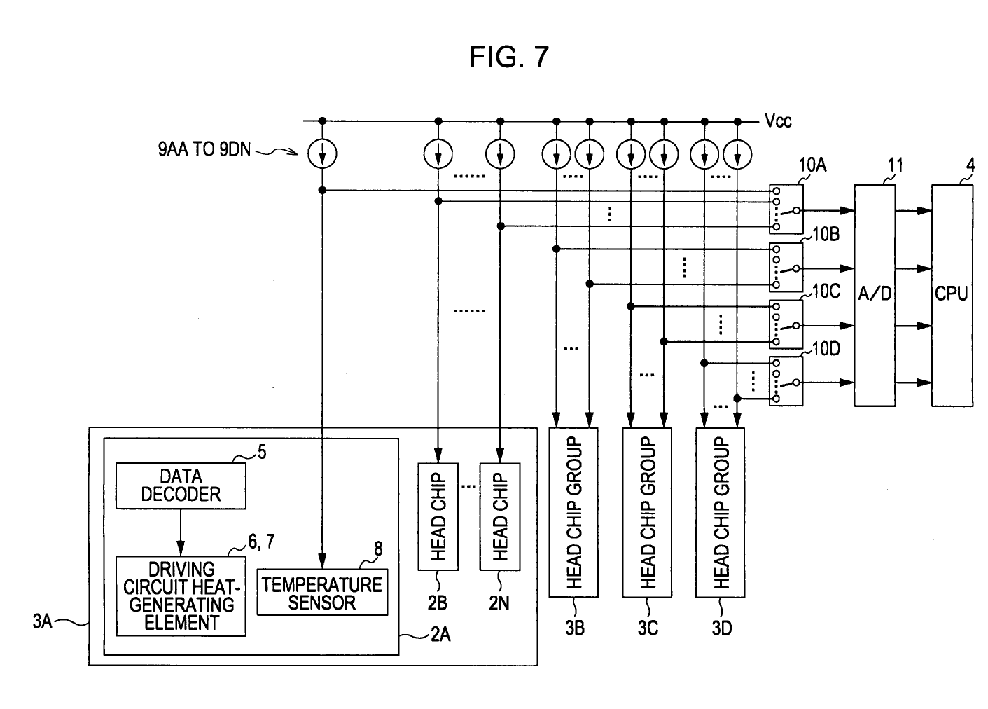

FIG. 1, in contrast with FIG. 7, is a block diagram showing the configuration for temperature measurement of head chips 35 in the printer 21. In the printer 21, each of head chip groups 36Y, 36M, 36C, and 36K is constituted by a plurality of head chips 35 (35A to 35N). Each head chip 35 (35A to 35N) is provided with a temperature sensor 51 whose resistance value changes with temperature, and a switch circuit 53 by which the temperature sensor 51 is connected to a constant current source 52. In this embodiment, as shown in FIG. 5, the temperature sensor 51 is constituted by a serial circuit of diodes 54A and 54B, which are temperature-sensitive elements, and the switch circuit 53 is constituted by a MOSFET 55.

Here, in the printer 21, the constant current source 52 connected to the temperature sensor 51 is provided on a motherboard 57 having a central processing unit (CPU) 56 mounted thereon in common with the head chips 35 (35A to 35N) of the head chip groups 36Y, 36M, 36C, and 36K on the central processing unit 56 side with respect to the center of the wiring pattern by which the central processing unit 56 is connected to each head chip 35 (35A to 35N). More specifically, the constant current source 52 is disposed immediately before an analog-to-digital conversion circuit 58. In the temperature sensor 51 of each head chip 35 (35A to 35N), ends of all the head chips 35 (35A to 35N) on the constant current source 52 side are connected and collected to one output line L1 on the flexible wiring substrate 45. Thereafter, the one output line L1 is connected to the constant current source 52 on the motherboard 57. As a result, in the printer 21, the switch circuits 53 of the head chips 35 (35A to 35N) are sequentially and selectively set to an ON state, and the constant current source 52 can be connected to the switch circuit 53 of each head chip 35 (35A to 35N).

The analog-to-digital conversion circuit 58 performs an analog-to-digital conversion process on the voltage at the end of the constant current source 52 on the head chip side, and outputs the result. The central processing unit 56 obtains the output value of the analog-to-digital conversion circuit 58 at a predetermined time, and thereby measures the temperature of each head chip 35 (35A to 35N).

Here, the central processing unit 56 is an arithmetic processing circuit for outputting image print data DATA1 to DATA64 in accordance with image data used for printing, and for controlling the driving of the heat generating element 38 provided in each head chip 35 (35A to 35N). The central processing unit 56 outputs image print data DATA1 to DATA64 in the form of serial data for each head chip 35 (35A to 35N). Therefore, in this embodiment, since the number of head chips is 64, the central processing unit 56 outputs the image print data DATA1 to DATA64 from a 64-bit bus line.

The central processing unit 56 multiplexes control data for controlling the switch circuit 53 of each head chip 35 (35A to 35N) with the image print data DATA1 to DATA64 and outputs the data. That is, as shown in parts (A) and (B) of FIG. 6, the central processing unit 56 outputs image print data DATA1 to DATA64 in units of one byte in synchronization with a predetermined synchronization signal SYNC. Also, as shown in parts (A1) and (B1) of FIG. 6, the central processing unit 56 outputs the image print data DATA1 to DATA64 in synchronization with a clock CK.

The central processing unit 56 sequentially and selectively sets a specific bit (D2) of image print data DATA1 to DATA64 to be output to each head chip 35 (35A to 35N) to an H level (part (B1) of FIG. 6) during a temperature measurement period, which is a fixed period immediately before the printing of one printing paper 24 is started. As a result, during the temperature measurement period, the switch circuits 53 of the head chips 35 (35A to 35N) are sequentially and selectively connected to the constant current source 52 (parts (C1) to (C3) of FIG. 6). When this period of time passes and the printing of the printing paper 24 is started, the image print data DATA1 to DATA64 is output in accordance with the image data used for printing. The central processing unit 56 corrects the image print data DATA1 to DATA64 to be output during the period of the printing in accordance with the temperature of each head chip, which has been detected during the immediately preceding measurement period, and prevents print mottling due to temperature differences in the head chips. This correction is performed so that, the higher the temperature of the head chip, the smaller the amount of heat generation of the heat generating element becomes, by varying the amount of energy to be applied to the heat generating element or by changing the number of ink droplets forming one dot in accordance with the temperature of the head chip.

Here, the head chip 35 (35A to 35N) of each of the head chip groups 36Y, 36M, 36C, and 36K inputs the image print data DATA1 to DATA64 output from the central processing unit 56 to a data decoder 61. The data decoder 61 makes a determination as to the logical level of a specific bit of the image print data DATA1 to DATA64 during the temperature measurement period immediately before the printing starts, and controls the on/off state of the switch circuit 53 on the basis of the determination result. When the temperature measurement period is completed, the operation of the driving circuit 39 is controlled on the basis of the image print data DATA1 to DATA64 in order to drive the heat generating element 38. The temperature measurement period is detected by counting sync SYNC by using page sync that defines a period in which one paper (not shown) is printed as a reference.

### (2) Operation of the Embodiment

In the above configuration, in the printer 21 (FIG. 2), after the printing paper 24 held in the paper tray 23 is rolled out by the paper feed roller 26, the transport direction is switched by the inversion roller 27, and the printing paper is transported toward the ejection port on the front side. In the printer 21, when the printing paper is transported toward the ejection port in the manner described above, corresponding ink is supplied from the ink cartridges Y, M, C, and K of yellow, magenta, cyan, and black, respectively, which are held in the head cartridge 30, to the printer head 31. This ink in the form of droplets is adhered to the printing paper 24, and a desired image is printed.

That is, in the printer 21 (FIGS. 3 and 4), the inks from the ink cartridges Y, M, C, and K are guided via a corresponding ink flow path 43 to the ink liquid chamber 40, where ink droplets are ejected from the nozzle 41 due to air bubbles generated by the applied heat of the heat generating element 38 and are adhered to the printing paper 24. As a result, in the printer 21, by selectively driving the heat generating elements 38 by using a desired driving circuit while the printing paper is being transported, a desired image can be printed.

Furthermore, in the printer head 31 (FIG. 3), head chips 35 are arrayed in a zigzag manner for each ink used for printing, thereby forming head chip groups 36Y, 36M, 36C, and 36K in charge of printing of yellow, magenta, cyan, and black, respectively. In the printer head 31 (FIG. 1), image print data DATA1 to DATA64 is supplied from the central processing unit 56 to these head chips 35, and the heat generating element 38 of each head chip 35 is driven on the basis of the image print data DATA1 to DATA64. As a result, a desired image can be printed under the control of the central processing unit 56.

However, in such a thermal type based on the driving of the heat generating elements 38, the temperature of the head chip 35 is increased due to the driving of the heat generating element 38, temperature differences occur among the head chips 35, and the temperature differences among the head chips 35 cause the amount of ink droplets to be ejected from each head chip 35 to vary. In this case, when the amount of ink droplets is not corrected at all, print mottling occurs.

In order to prevent the print mottling, it is necessary to measure the temperature of each head chip 35 and control the driving of the heat generating element 38. However, if an output signal of the temperature sensor provided in each head chip 35 is guided to the central processing unit 56 side and the temperature is measured, wiring corresponding to the number of head chips becomes necessary, and the configuration of the motherboard on which the central processing unit 56 is mounted and the wiring that connects the motherboard to the head chip becomes markedly enlarged (see FIG. 7).

Accordingly, in this embodiment, the outputs of the temperature sensors 51 are collected to one output line L1 in all the head chips. The one output line L1 is connected to the constant current source 52 that drives the temperature sensors 51 and is further input to the analog-to-digital conversion circuit 58. The output value of the analog-to-digital conversion circuit 58 is input to the central processing unit 56. Each of the head chip 35 is provided with a switch circuit 53 that connects the temperature sensor 51 to the constant current source 52, and the switch circuits 53 are sequentially and selectively turned on, causing the central processing unit 56 to sequentially measure the temperature of each head chip 35.

As a result, in the printer 21, by connecting the head chips 35 to the central processing unit 56 side by using one output line L1, it is possible to measure the temperature of each head chip 35. It is possible to miniaturize the motherboard 57 on which the central processing unit 56 is mounted and the wiring that connects the motherboard 57 to the head chip 35, and it is possible to miniaturize the configuration for temperature measurement in comparison with the related art. Furthermore, selection circuits having an analog signal processing circuit configuration, which are selection circuits 10A to 10D used with reference to FIG. 7, do not need to be used, making it possible to simplify the configuration.

Furthermore, since a constant current source does not need to be provided for each head chip 35, it is possible to simplify the configuration in comparison with the related art and reduce consumption of power.

Furthermore, when the outputs of the temperature sensors 51 are collected to one output line L1 and connected to the constant current source 52, and the temperature of each head chip 35 is measured under the control of the switch circuit 53, it is possible to reduce the deterioration of the measurement accuracy due to noise that sneaks to this one line in comparison with the related art.

In particular, in the printer 21, the constant current source 52 is provided on the central processing unit 56 side with respect to the intermediate point of the wiring that connects the head chips 35 to the central processing unit 56, and furthermore, the constant current source 52 is provided immediately before the analog-to-digital conversion circuit 58. As a result, it is possible to shorten the length of the connection line between the constant current source 52 and the analog-to-digital conversion circuit 58, which are susceptible to influences of noise, and it is possible to reduce the deterioration of the measurement accuracy due to noise.

That is, in the central processing unit 56, during the temperature measurement period immediately before the printing of one printing paper is started, switch circuits 53 of each head chip 35 are sequentially and selectively switched to an ON state. As a result, the temperature sensors 51 of each head chip 35 are sequentially and selectively connected to the constant current source 52, and the output value of the analog-to-digital conversion circuit 58 is sequentially received in response to the control of the switch circuit 53 in order to measure the temperature of each head chip 35. Furthermore, the driving of the heat generating element 38 provided in each head chip 35 is controlled in accordance with the measured temperature. As a result, print mottling is prevented, and a desired image is printed.

In the printer 21, control data related to the control of the switch circuits 53 is transmitted during the temperature measurement period by using image print data DATA1 to DATA64 used to control the driving of the heat generating element 38 in each head chip 35. Control data used to control the switch circuits 53 is multiplexed with the image print data DATA1 to DATA64 used to drive the heat generating elements 38 and is transmitted to the head chips 35.

As a result, in the printer 21, even if wiring is not separately provided, it is possible to control the switch circuits 53 by using the central processing unit 56. This also makes it possible to prevent an increase in the number of wirings that connect the central processing unit 56 to the head chips 35 and possible to miniaturize the configuration for temperature measurement in comparison with the related art.

The temperature sensor 51 is constituted by a serial circuit of diodes 54A and 54B, and the switch circuit 53 is formed by a MOSFET. As a result, it is possible for the step of producing the head chip 35 in the semiconductor manufacturing process to produce the temperature sensor 51 and the switch circuit 53 in combination.

### (3) Advantages of the Embodiment

According to the above configuration, the electrical current source for temperature measurement is shared among a plurality of head chips so as to selectively connect the temperature sensors of each head chip to the electrical current source, and the temperature of each head chip is measured at the end of the electrical current source side. This makes it possible to miniaturize the configuration for temperature measurement in comparison with the related art.

More specifically, by performing an analog-to-digital conversion process on the voltage at the end of the electrical current source on the temperature sensor side and inputting the result to the arithmetic processing circuit, it is possible for the arithmetic processing circuit to control the driving of the heat generating elements so that print mottling due to temperature difference among head chips is prevented.

Furthermore, by multiplexing control data used to control the switch circuits with image print data used to drive the heat generating elements and transmitting the data to the head chips, it is possible to transmit control data used to control the switch circuit by using a transmission line for the image print data, and it is possible to miniaturize the configuration for temperature measurement by preventing an increase in the number of wirings.

Furthermore, by configuring the temperature sensors by using diodes and by configuring the switch circuits by using transistors, it is possible to produce a temperature sensor and a switch circuit without increasing the number of steps of manufacturing the head chip.

Furthermore, as a result of providing the electrical current source on the central processing unit side with respect to the intermediate point of the wiring that connects a plurality of head chips to the central processing unit that is a heat-generating-element control circuit, it is possible to prevent the deterioration of the measurement accuracy due to sneaking of noise.

### Second Embodiment

In the above-described embodiment, a case in which control data for switch circuits is transmitted through a transmission line of image print data has been described. The present invention is not limited to this case, and control data for switch circuits may be transmitted through a transmission line differing from that for image print data. In this case, control data may be transmitted in common with a plurality of head chips, thereby preventing an increase in the number of wirings.

In the above-described embodiment, a case in which outputs of temperature sensors are collected in all the head chips provided in the printer head has been described. The present invention is not limited to this case. The number of head chips to be collected to one output line, for example, in the case they are collected for each head chip group according to ink, can be set variously as necessary.

In the above-described embodiment, a case in which a temperature sensor is constituted by a diode has been described. The present invention is not limited to this case, and a temperature sensor can be configured variously, such as, for example, a temperature sensor being constituted by a temperature sensitive element such as a thermistor.

In the above-described embodiment, a case in which the present invention is applied to a thermal line printer has been described. However, the present invention is not limited to this case, and can be widely applied to various kinds of thermal printers.

In the above-described embodiment, a case in which the present invention is applied to a printer and ink droplets are ejected by driving heat generating elements has been described. However, the present invention is not limited to this case, and can be widely applied to a droplet ejecting apparatus for ejecting various kinds of liquid medicine. Examples of this type of liquid medicine include various kinds of reagents, dyes, a coating agent, and an etching agent.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid ejecting apparatus for ejecting droplets by driving heat generating elements, the liquid ejecting apparatus comprising:
an electrical current source configured to output temperature measurement current;
a plurality of head chips, each having a heat generating element, a temperature sensor whose resistance value changes with temperature, a switch circuit that connects the temperature sensor to the electrical current source, and a switch-circuit control circuit configured to control the switch circuit; and
a heat-generating-element control circuit configured to measure temperatures of the plurality of head chips and controlling the driving of the heat generating elements via an end of the electrical current source on the temperature sensor side,
wherein the temperature sensors of the plurality of head chips are sequentially and selectively connected to the electrical current source by the switch circuits of the plurality of head chips, and the temperatures of the plurality of head chips are measured by the heat-generating-element control circuit.

2. The liquid ejecting apparatus according to claim 1, wherein the heat-generating-element control circuit includes:
an analog-to-digital conversion circuit configured to perform an analog-to-digital conversion process on a voltage at the end of the electrical current source on the temperature sensor side, and
an arithmetic processing circuit configured to obtain an output value of the analog-to-digital conversion circuit and to control the driving of the heat generating elements.

3. The liquid ejecting apparatus according to claim 1, wherein the heat-generating-element control circuit multiplexes control data for controlling the switch circuit with image print data with which the heat generating element is driven and transmits the multiplexed data to the head chip.

4. The liquid ejecting apparatus according to claim 1, wherein the temperature sensor is a diode, and the switch circuit is a transistor.

5. The liquid ejecting apparatus according to claim 1, wherein the electrical current source is provided on the heat-generating-element control circuit side with respect to an intermediate point of wiring that connects the plurality of head chips to the heat-generating-element control circuit.

6. A method for controlling a liquid ejecting apparatus for ejecting droplets by driving heat generating elements, the liquid ejecting apparatus including an electrical current source configured to output temperature measurement current, and a plurality of head chips, each having a heat generating element, a temperature sensor whose resistance value changes with temperature, and a switch circuit that connects the temperature sensor to the electrical current source, the control method comprising the steps of:
sequentially and selectively connecting the temperature sensors of the plurality of head chips by using the switch circuits of the plurality of head chips, and sequentially measuring temperatures of the plurality of head chips via an end of the electrical current source on the temperature sensor side; and
controlling the driving of the heat generating elements on the basis of the measurement result in the temperature measurement.
